(19) United States
(12) Patent Application Publication
(10) Pub. No.: US 2022/0238956 A1
(43) Pub. Date: Jul. 28, 2022

(54) PROCESS FOR PREPARING A COATED BATTERY SEPARATOR

(71) Applicant: SOLVAY SPECIALTY POLYMERS ITALY S.P.A., Bollate (IT)

(72) Inventors: Maurizio BISO, Milano (IT); Matilde Valeria SOLMI, Arese (IT)

(21) Appl. No.: 17/611,404

(22) PCT Filed: Jun. 29, 2020
(86) PCT No.: PCT/EP2020/068210

§ 371 Date: Nov. 15, 2021

(30) Foreign Application Priority Data
Jul. 1, 2019 (EP) 19183737.6

(51) Int. Cl. H01M 50/423; H01M 50/403; H01M 50/449; C08G 73/14

(52) U.S. Cl. CPC H01M 50/423; C08G 73/14; H01M 50/449; H01M 50/403

(57) ABSTRACT

The present invention pertains to salified polyamide-imide polymers and their use as for the manufacture of electrochemical cell components, such as separators.

### CROSS-REFERENCE TO RELATED APPLICATIONS

This application claims priority to European application No. 19183737.6 filed on Jul. 1, 2019, the whole content of this application being incorporated herein by reference for all purposes.

### TECHNICAL FIELD

The present invention pertains to salified polyamide-imide polymers and their use for the manufacture of electrochemical cell components, such as separators.

### BACKGROUND ART

Lithium-ion batteries have become essential in our daily life. In the context of sustainable development, they are expected to play a more important role because they have attracted increasing attention for uses in electric vehicles and renewable energy storage.

Separator layers are important components of batteries. These layers serve to prevent contact of the positive electrode and a negative electrode of the battery while permitting electrolyte to pass there through. Additionally, battery performance attributes such as cycle life and power can be significantly affected by the choice of separator.

In a current-technology lithium secondary battery, a polyolefin-based porous film having a thickness of 6 to 30 micrometres is used as a separator. For the material of the separator, polyethylene (PE) having a low melting point can be used for securing a so-called shutdown effect, namely, melting a resin of the separator at or below a thermal runaway (abnormal heating) temperature of the battery so as to close the pores, thereby increasing the internal resistance of the battery and improving the safety of the battery at the time of short-circuit or the like.

For the separator, for example, a uniaxially or biaxially stretched film is used in order to provide porosity and improve the strength. Distortion occurs in the film due to the stretching, and thus when exposed to a high temperature, contraction will occur due to residual stress. The contraction temperature is extremely closer to the melting point, that is, the shutdown temperature. As a result, in a case of using a polyolefin-based porous film separator, when the temperature of the battery reaches the shutdown temperature due to anomalies in charging or the like, the current must be decreased immediately for preventing the battery temperature from rising.

If the pores are not closed sufficiently and the current cannot be decreased immediately, the battery temperature will be raised easily to the contraction temperature of the separator, causing a risk of thermal runaway due to internal short-circuit.

In order to prevent a short-circuit caused by the thermal contraction, methods of using separators of a microporous film of heat-resistant resin or a nonwoven fabric have been proposed. For example, EP3054502 (ASAHI KASEI KABUSHIKI KAISHA) discloses a separator formed of a porous film having a polyolefin microporous film and a thermoplastic polymer coating layer covering at least a part of at least one of the surfaces of the polyolefin microporous film, wherein the thermoplastic polymer coating layer contains a thermoplastic polymer selected from the group consisting of a diene polymer, an acrylic polymer and a fluorine polymer.

Though the above-mentioned separators made of a heat-resistant resin have an excellent dimensional stability at high temperature and can be made thinner, they do not have the so-called shutdown characteristic, namely, a characteristic that the pores will be closed at high temperature, the separator cannot provide sufficient safety at an abnormality, specifically when the battery temperature rises rapidly due to an external short-circuit or an internal short-circuit.

As technology for solving such problems, for example, U.S. Pat. No. 9,343,719 (MITSUBISHI PLASTICS, INC.) shows a separator made of a porous layer containing metal oxide and a polymer binder which is laminated on at least one surface of a porous polyolefin resin film. The separator is produced by applying a coating solution containing the metal oxide, the polymer binder and a volatile acid on at least one surface of the porous polyolefin resin film.

New binders based on polyamide-imides (PAI) for use as coating of porous polyolefin resin film have been studied. However, most PAIs are only soluble in organic solvents such as N-methyl-2-pyrrolidone (NMP).

JP2016081711 (TDK CORP) discloses a separator comprising a porous layer including polyolefin as its matrix and a PAI-containing porous layer laminated on at least one face of the porous layer, the lamination being produced by casting a solution of said PAI in NMP onto said polyolefin.

In the technical field of batteries, notably of lithium batteries, the problem of providing a coated separator capable of providing heat resistance properties and shutdown function to the separator substrate material and which at the same time reduces the weight of the separator and of the overall battery and are prepared by coating compositions including environmentally-friendly solvents such as water, is felt.

### SUMMARY OF INVENTION

Surprisingly, the Applicant found that when a separator for an electrochemical cell prepared by at least partially coating a substrate layer with an aqueous composition comprising at least one salified polyamide-imide, said problem can be solved.

Thus, in a first aspect, the present invention relates to a process for the preparation of a coated separator for use in an electrochemical cell, said process comprising the following steps:

i) providing a non-coated substrate layer [layer (P)];

ii) providing an aqueous composition (C) comprising an aqueous medium and at least one salified polyamide-imide polymer (PAI-Salt) comprising more than 50% by moles of recurring units R_{PAI} selected from the group consisting of units of any of general formulae (R_{PAI}-a) (R_{PAI}-b) and (R_{PAI}-c):

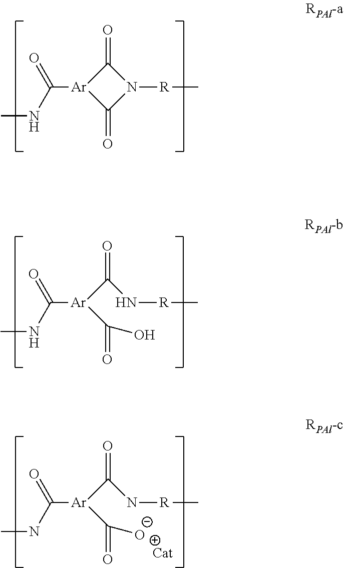

provided that R_{PAI}-c represents at least 30% by moles of recurring units in the salified polyamide-imide (PAI-Salt),
wherein:
Ar is a trivalent aromatic group; preferably Ar is selected from the group consisting of the following

structures

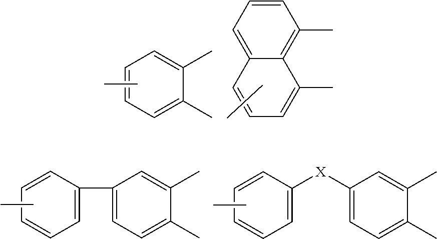

and corresponding optionally substituted structures,

wherein X is selected from the group consisting of —O—, —C(O)—, —CH₂—, —C(CF₃)₂—, —(CF₂)ₙ—, with n being an integer from 1 to 5;

X is selected from the group consisting of —O—, —C(O)—, —CH₂—, —C(CF₃)₂—, and

—(CF₂)ₚ—;

n is an integer from 1 to 5;

R is a divalent aromatic group selected from the group consisting of:

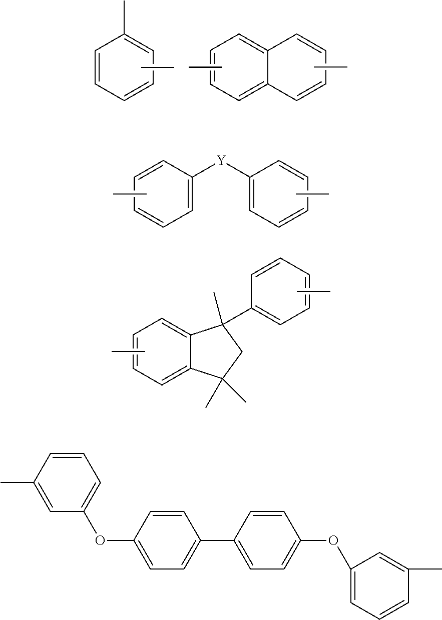

and corresponding optionally substituted structures,

Y is selected from the group consisting of —O—, —S—, —SO₂—, —CH₂—, —C(O)—, —C(CF₃)₂—, —(CF₂)_{q}—, q being an integer from 0 to 5, and

Cat⁺ is a monovalent cation preferably selected from alkali metals cations, more preferably is selected from Na⁺, K⁺ and Li⁺, even more preferably is Li⁺;

iii) applying said composition (C) obtained in step ii) at least partially onto at least one portion of said substrate layer (P), thus providing an at least partially coated substrate layer; and

iv) drying said at least partially coated substrate layer obtained in step iii) to provide a coated separator.

In a second aspect, the present invention relates to a coated separator for an electrochemical cell obtainable by the process as defined above.

In a third aspect, the present invention relates to an electrochemical cell, such as a secondary battery or a capacitor, comprising the coated separator as defined above.

### DESCRIPTION OF EMBODIMENTS

In the context of the present invention, the term “weight percent” (wt %) indicates the content of a specific component in a mixture, calculated as the ratio between the weight of the component and the total weight of the mixture. When referred to the recurring units derived from a certain monomer in a polymer/copolymer, weight percent (wt %) indicates the ratio between the weight of the recurring units of such monomer over the total weight of the polymer/copolymer. When referred to the total solid content (TSC) of a liquid composition, weight percent (wt %) indicates the ratio between the weight of all non-volatile ingredients in the liquid.

By the term “separator”, it is hereby intended to denote a porous monolayer or multilayer polymeric material which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

By the term “aqueous”, it is hereby intended to denote a medium comprising pure water and water combined with other ingredients which do not substantially change the physical and chemical properties exhibited by water.

In the context of the invention, the term “substrate layer” is hereby intended to denote either a monolayer substrate consisting of a single layer or a multilayer substrate comprising at least two layers adjacent to each other.

The layer (P) can be made by any porous substrate or fabric commonly used for a separator in electrochemical device, comprising at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene and polypropylene, or a mixture thereof. Preferably, the layer (P) is polyethylene or polypropylene.

The thickness of layer (P) is not particularly limited and is typically from 3 to 100 μm, preferably from 5 to 50 μm.

In the formulae that follow, the floating amide bond indicates that the amide can be bonded to either of the closest carbons to the floating amide bond on the ring. In other words,

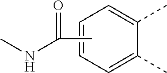

H in each formula represents both

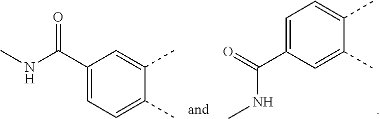

In a preferred embodiment of the present invention the Cat⁺ in the recurring units R_{PAI}-c is Li⁺, and the PAI-Salt is lithium polyamide-imide (LiPAI).

In some embodiments, recurring units R_{PAI}-a in the LiPAI are selected from at least one recurring unit of formula:

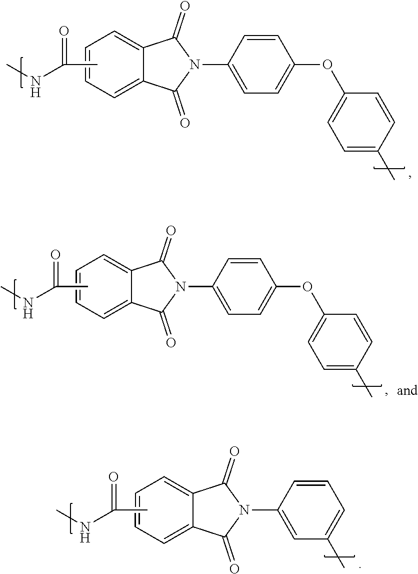

In some embodiments, recurring units R_{PAI}-b in the LiPAI are selected from at least one recurring unit of formula:

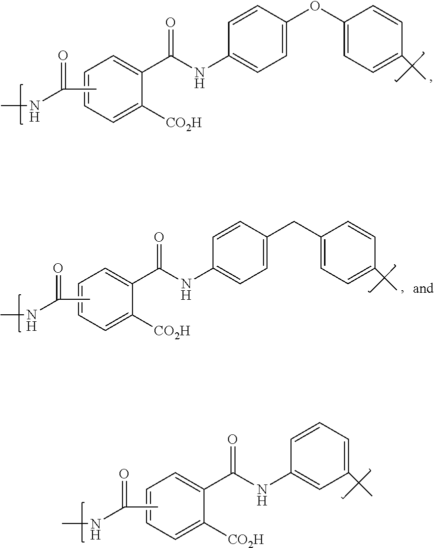

In some embodiments, recurring units R_{PAI}-c in the LiPAI are selected from at least one recurring unit of formula:

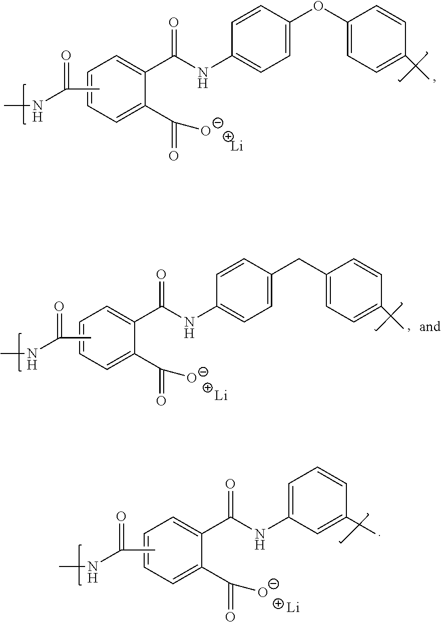

In some embodiments, the recurring units R_{PAI}-a, R_{PAI}-b, and R_{PAI}-c in the LiPAI are respectively units of formulae:

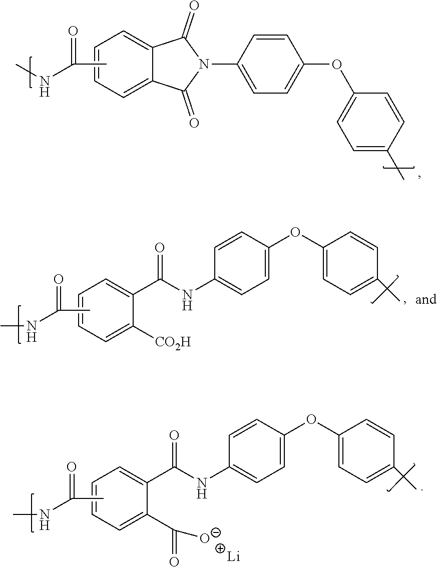

Preferably, recurring units R_{PAI}-c in the LiPAI are units of formula:

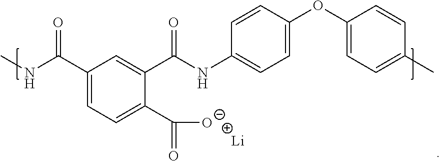

In some embodiments, the recurring units R_{PAI}-a, R_{PAI}-b, and R_{PAI}-c in the LiPAI are respectively units of formulae:

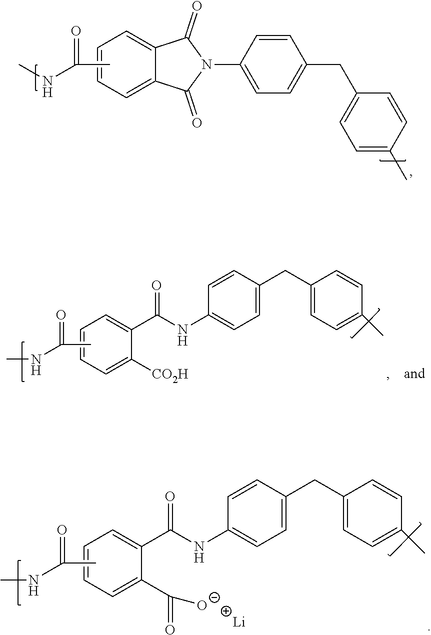

In some embodiments, the recurring units R_{PAI}-a, R_{PAI}-b, and R_{PAI}-c in the LiPAI are respectively units of formulae:

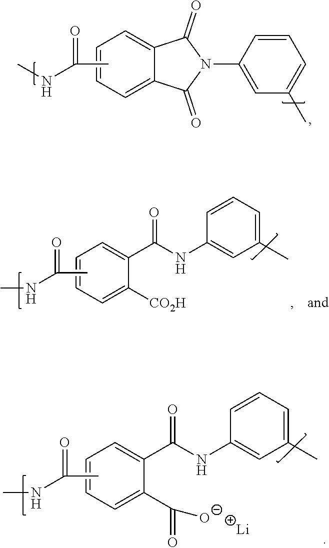

In some embodiments, the LiPAI comprises more than one, for example two, of each of recurring units R_{PAI}-a, R_{PAI}-b, and R_{PAI}-c. Accordingly, in some aspects the LiPAI comprises:

a) recurring units R_{PAI}-a of formulae:

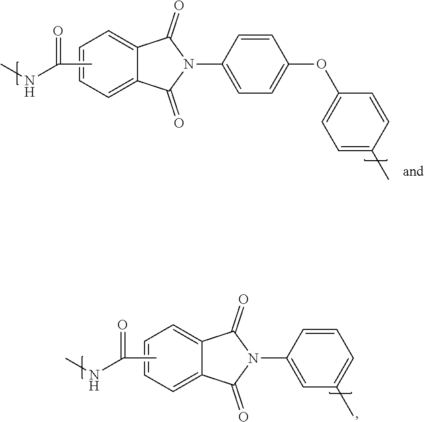

b) recurring units R_{PAI}-b of formulae:

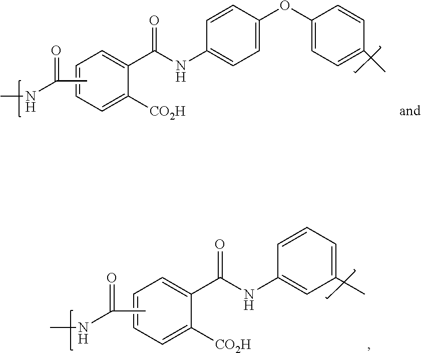

and

c) recurring units R_{PAI}-c of formulae:

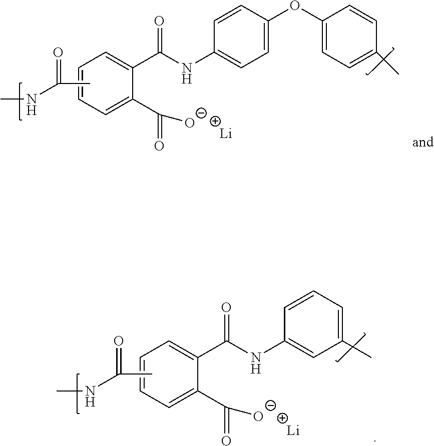

In some embodiments, the PAI-Salt includes less than 50% by moles, preferably less than 49% by moles, 45% by moles 40% by moles 30% by moles 20% by moles, 10% by moles, 5% by moles, 2% by moles, 1% by moles of the R_{PAI}-a recurring units. In some embodiments, the PAI-Salt is free of recurring units R_{PAI}-a.

In some embodiments, the PAI-Salt includes less than 70% by moles, preferably less than 60% by moles, 50% by moles, 40% by moles, 30% by moles, 20% by moles, 10% by moles, 5% by moles, 2% by moles, 1% by moles of recurring units R_{PAI}-b.

Preferably, the PAI-Salt includes at least 30% by moles, 35% by moles, 40% by moles, 45% by moles, 50% by moles, 60% by moles, 70% by moles, 80% by moles, 90% by moles, 95% by moles, 99% by moles of recurring units R_{PAI}-c. Most preferably, all of the recurring units in the PAI-Salt are recurring units R_{PAI}-c.

In some embodiments, the mole ratio R_{PAI}-a/(R_{PAI}-b+R_{PAI}-c) is 1.0 or less, preferably 0.9, 0.8. 0.7, 0.6, 0.5, 0.4. 0.3, 0.2, 0.1 or less.

In some embodiments, the mole ratio R_{PAI}-c/(R_{PAI}-a+R_{PAI}-b) is 0.5, 0.6, 0.7, 0.8, 0.9, 1.0 or more. For example, the mole ratio R_{PAI}-c/(R_{PAI}-a+R_{PAI}-b) is preferably greater than 2, 5, 10, 20, 30, 40, 50, 60, 70, 80, 90, 95, 99.

In a preferred embodiment, the amount of recurring units R_{PAI}-b ranges from 0 to 50% by moles, and the amount of recurring units R_{PAI}-c ranges from 50 to 100% by moles.

Determination of the relative amounts of recurring units R_{PAI}-b and R_{PAI}-c in the PAI-Salt can be performed by any suitable method. For example the amount of recurring units R_{PAI}-a (degree of imidization) can be assessed by NMR and the amount of recurring units R_{PAI}-b and R_{PAI}-c can be assessed by NMR, elemental analysis, or titration.

The PAI-Salt has an acid equivalent greater than 300 grams per equivalent (g/eq) of acid. Preferably, the PAI-Salt has an acid equivalent greater than 325 g/eq, more preferably greater than 350 g/eq, and most preferably at least 375 g/eq or more.

The PAI-Salt is water soluble. As used herein “water soluble” or “soluble in water” means that at least 99 wt % of the PAI-Salt, based on the total weight of the PAI-Salt, dissolves in deionized water to form a homogenous solution at 23° C. with moderate stirring.

In some embodiments, the PAI-Salt has a number average molecular weight (Mn) of at least 1000 g/mol, preferably at least 2000 g/mol, more preferably at least 4000 g/mol. In some embodiments, the PAI-Salt has a number average molecular weight (Mn) of at most 10000 g/mol, preferably at most 8000 g/mol, more preferably at most 6000 g/mol.

The PAI-Salt used in the present invention can be prepared from the corresponding polyamide-imide (PAI) by neutralizing amic acid groups with a corresponding alkali metal salt in a solvent.

The LiPAI used in the present invention can be prepared from the corresponding polyamide-imide (PAI) by neutralizing amic acid groups with a lithium salt in a solvent.

As used herein, “polyamide-imide (PAI)” means any polymer comprising: 0 to 50% by moles of at least one recurring unit R_{PAI}-a, of formula:

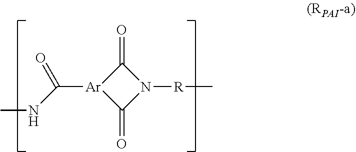

and

50 to 100% by moles of at least one recurring unit R_{PAI}-b of formula:

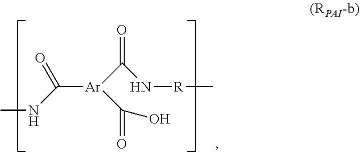

provided that recurring units R_{PAI}-a and R_{PAI}-b collectively represent more than 50% by moles, preferably at least 60% by moles, 75% by moles, 90% by moles, 95% by moles, 99% by moles of recurring units in the PAI, and Ar and R are as defined above.

Polyamide-imide polymers are available from Solvay Specialty Polymers USA, L.L.C. under the trademark, TORLON® PAI.

PAI can be manufactured according to known methods in the art. For example, processes for preparing PAI polymers are disclosed in detail in British Patent No. 1,056,564, U.S. Pat. Nos. 3,661,832 and 3,669,937.

PAI can be manufactured by a process including the polycondensation reaction between at least one acid monomer chosen from trimellitic anhydride and trimellitic anhydride monoacid halides and at least one comonomer chosen from diamines and diisocyanates. In some embodiments, the molar ratio of the at least one acid monomer to the comonomer is 1:1.

Among the trimellitic anhydride monoacid halides, trimellitic anhydride monoacid chloride (TMAC) is preferred:

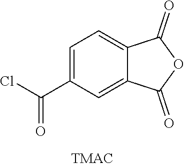 [SMILES: O=C(Cl)c1ccc2c(c1)C(=O)OC2=O]

When polymerized, the acid monomers can exist in either an imide form or an amic acid form.

The comonomer can comprise one or two aromatic rings. Preferably, the comonomer is a diamine. More preferably, the diamine is selected from the group consisting of 4,4′-diaminodiphenylmethane (MDA), 4,4′-diaminodiphenylether (ODA), m-phenylenediamine (MPDA), and combinations thereof:

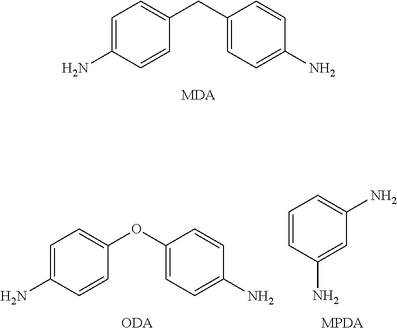

The alkali metal salt can be any salt capable of neutralizing amic acid groups.

In some embodiments for preparing LiPAI, the lithium salt is selected from the group consisting of lithium carbonate, lithium hydroxide, lithium bicarbonate, and combinations thereof, preferably lithium carbonate.

The solvent can be any solvent capable of dissolving the alkali metal salt and the resulting PAI-Salt.

In some embodiments for preparing LiPAI the solvent is preferably selected from at least one of water, NMP, and alcohols, such as, for example, methanol, isopropanol, and ethanol.

Preferably, the solvent includes less than 5 wt %, preferably less than 2 wt %, preferably less than 1 wt % of NMP. More preferably, the solvent is free of NMP. Most preferably, the solvent is water.

Preferably the concentration of the alkali metal salt in the solvent ranges from 0.1 to 30 wt %, preferably from 1 to 30 wt %, more preferably from 5 to 15 wt %, based on the total weight of the solvent and the alkali metal salt.

The LiPAI used in the present invention are prepared by using the concentration of the lithium salt in the solvent that allows providing at least 0.75 eq, 1 eq, 1.5 eq, 2 eq, 2.5 eq, 3 eq, 4, eq of lithium to acid groups.

The concentration of the lithium salt in the solvent preferably provides at most 5 eq, preferably at most 4 eq. of lithium to acid groups.

The solution of the alkali metal salt, preferably of the lithium salt, and the PAI (or PAI-Salt) is preferably heated to a temperature ranging from 50° C. to 90° C., preferably from 60° C. to 80° C., most preferably from 65° C. to 75° C., preferably for a time ranging from few seconds to 6 hours.

The pH of the PAI-Salt obtained as above detailed is preferably lowered by adding to the reaction mixture after salification at least one source of acid, for example, as a mineral acid or as an organic acid such as acetic acid, formic acid, oxalic acid, benzoic acid, or as an acid generating species, such as a polymer having acidic sites.

Following salification, the concentration of the PAI-Salt in the solution preferably ranges from 1 to 20 wt %, preferably 5 to 15 wt %, most preferably 5 to 10 wt %, based on the total weight of the PAI-Sal and the solvent.

The PAI-Salt can be isolated as a solid from the solution and optionally stored for later use.

The composition (C) used in the present invention includes at least one PAI-Salt as above defined and an aqueous medium. The aqueous medium preferably contains essentially water.

Composition (C) may further comprise other ingredients, such as, for example, at least one wetting agent and/or at least one surfactant. As the wetting agent, mention can be made to polyhydric alcohols and to polyorganosiloxanes. As the surfactant, any of a cationic surfactant, an anionic surfactant, an amphoteric surfactant and a non-ionic surfactant can be used.

In a preferred embodiment of the invention, composition (C) comprises water, at least one LiPAI and a wetting agent.

The composition (C) may further comprise one or more than one additional additive.

Optional additives in composition (C) include notably viscosity modifiers, as detailed above, anti-foams, non-fluorinated surfactants, and the like.

The total solid content (TSC) of the composition (C) of the present invention is typically comprised between 1 and 15 wt % preferably from 2 to 10 wt %, over the total weight of the composition (C). The total solid content of the composition (C) is understood to be cumulative of all non-volatile ingredients thereof, notably including PAI-Salt and any solid, non-volatile additional additive.

Composition (C) can be prepared by any common procedure known in the art, by mixing the components under stirring in any suitable equipment to obtain a homogeneous mixture.

In step iii) of the process of the present invention, composition (C) obtained in step (ii) is at least partially applied onto at least one portion of said substrate layer (P) by a technique selected from casting, spray coating, rotating spray coating, roll coating, doctor blading, slot die coating, gravure coating, ink jet printing, spin coating and screen printing, brush, squeegee, foam applicator, curtain coating, vacuum coating.

In a preferred embodiment of the invention, the substrate layer (P) to be at least partially coated by the composition (C) is pre-heated before application of composition (C). Pre-heating is preferably carried out at a temperature ranging from 30 to 70° C.

Pre-heating the substrate layer (P) allows a faster and improved evaporation of the aqueous medium present in composition (C) in the following drying step iv). This may result in lower defects in the coated separator at the end of the process.

Application of composition (C) onto at least one portion of substrate layer (P) is carried out in an amount that provides an at least partially coated substrate layer wherein the coating has a wet thickness that is in the range of from 0.5 to 100 μm, preferably of from 2 to 50 μm.

In step iv) of the process of the invention, the at least partially coated substrate layer obtained in step iii) is dried preferably at a temperature comprised between 20° C. and 200° C., preferably between 60° C. and 100° C.

The thickness of the dry coating after the drying step iv) is preferably in the range of from about 0.1 to 10 μm, preferably from 1 and 5 μm.

The process of the present invention for the preparation of a coated separator may include a further step of hot-pressing the coated separator after step iv).

Hot-pressing is a method of performing heating and pressing simultaneously.

Hot-pressing may be carried out using metal roll, a roll press machine using a resilient roller and a flat plate press machine or the like. The temperature of the hot-press is preferably from 60 to 110° C., more preferably from 70 to 105° C., particularly preferably is 90 to 100° C.

Pressure of the heat press is preferably 0.1 to 10 MPa, more preferably from 0.3 to 5 MPa, still more preferably it is from 0.5 to 3 MPa. Time for applying the hot press ranges from few seconds to 50 minutes, depending on the equipment used for hot pressing.

With the temperature, pressure and range of time for performing hot-pressing, the separator can be firmly bonded.

In a second aspect, the present invention relates to a separator for an electrochemical cell obtainable by the process as above defined.

The inventors found that the coated separator according to the invention show an improved shape stability at high temperatures in comparison to separators of the prior art

In addition, the coated separators of the present invention have the shutdown function, which is highly desirable to improve the safety of batteries.

In still another aspect, the present invention relates to an electrochemical cell, such as a secondary battery or a capacitor, comprising the at least partially coated separator as defined above.

In still another embodiment, the present invention pertains to a secondary battery comprising:
a positive electrode,
a negative electrode,
a coated separator, wherein the coated separator is the coated separator of the invention.

Should the disclosure of any patents, patent applications, and publications which are incorporated herein by reference conflict with the description of the present application to the extent that it may render a term unclear, the present description shall take precedence.

The invention is described hereunder in more detail with reference to the following examples, which are provided with the purpose of merely illustrating the invention, with no intention to limit its scope.

Experimental Part

Raw Materials

Torlon® AI-50 available from Solvay Specialty Polymers USA, LLC;

Trimellitic acid chloride (TMAC) and oxydianiline (ODA) available from Aldrich;

N-methylpyrrolidone (NMP) available from VWR International or Sigma Aldrich;

Sodium Dodecyl Sulfate (SDS) commercially available as Amepon from Ametech dissolved in H₂O (TSC=28%)

Polyolefin substrate (PO): commercially available as Tonen® F20BHE, PE material, 20 μm, 45% porosity.

BYK-349: polyether side chains and silicone backbone commercially available from BYK.

Preparation 1: TMAC-ODA (50-50) PAI Copolymer

ODA monomer (60.0 g, 0.3 moles) was charged into a 4-neck jacketed round-bottom flask fitted with overhead mechanical stirrer. NMP (250 mL) was charged to the flask and the mixture was cooled to 10° C. with mild agitation under a nitrogen atmosphere. The flask was fitted with a heated addition funnel to which TMAC (64.0 g, 0.3 moles) was charged and heated to a minimum of 100° C. The molten TMAC was added to the solution of diamine in NMP at a rate sufficient not to exceed 40° C. with vigorous agitation. Once the addition was complete, external heating was applied to maintain 35-40° C. for 2 hours. Additional NMP (50 mL) was added and the reaction mixture discharged into a 500 mL beaker. The polymer solution was slowly added to water (4000 mL) in a stainless steel high-shear mixer. The precipitated polymer was filtered and washed multiple times with water to remove residual solvent and acid by-product.

Degree of imidization, as measured by acid number titration was no higher than 50 mol %.

Preparation 2: Lithiated TMAC-ODA (50-50) Copolymer—5 wt % Polymer and 4 Eq Lithium

Deionized water (188 mL) was charged to a 4-neck jacketed round-bottom flask fitted with overhead mechanical stirrer. Lithium carbonate (4.69 g, 0.067 mol) was added and the solution heated to 70° C. With vigorous agitation, the TMAC-ODA (50-50) PAI (60.5 g at 20.7% solids) was added in step-wise fashion, allowing each portion to dissolve prior to further addition. After the entire polymer was charged to the reactor, heating was continued for 1-2 hours, at which time the homogenous solution was discharged.

Preparation 3: Lithiated TMAC-ODA (50-50) Copolymer—5 wt % Polymer and 4 Eq. Lithium with Wetting Agent

Under mixing, to a composition prepared as in Preparation 2 SDS and H₂O were added in order to achieve a final TSC (total solid content) of 5%. In the composition, 90% of the TSC was the polymer and 10% SDS.

### Example 1

The PO was fixed at a glass support.

The PO was pre-heated in a ventilated oven at temperature of 50° C.

Casting of the solution obtained as in Preparation 3 onto the PO was performed at 40 μm of wet thickness to achieve a final dry coating of 1-2 μm. The supporting plate was kept at 50° C. all time during of the coating. Drying was performed at 70° C. for 30 min in ventilated oven. Once dried, the same procedure was repeated for the second side of the PO.

### Example 1a

The same procedure for preparing a coated separator as in Example 1 was followed. The coated PO was then hot-pressed at 1 MPa at 95° C. for 25 minutes.

### Example 2

The same procedure for preparing a coated separator as in Example 1 was followed, but avoiding the preliminary step of pre-heating.

### Example 2a

The same procedure for preparing a coated separator as in Example 2 was followed. The coated PO was then hot-pressed at 1 MPa at 95° C. for 25 minutes.

### Example 3

The same procedure for preparing a coated separator as in Example 2 was followed, but drying was performed at room temperature for 15 hours.

### Example 3a

The same procedure for preparing a coated separator as in Example 3 was followed. The coated PO was then hot-pressed at 1 MPa at 95° C. for 25 minutes.

### Example 4

The PO was fixed at a glass support.

Casting of the solution obtained as in Preparation 3 onto one side of the PO was performed at 40 μm of wet thickness to achieve a final dry coating of 1-2 μm. Drying was performed at room temperature for 15 hours in ventilated oven.

### Example 4a

The same procedure for preparing a coated separator as in Example 4 was followed. The coated PO was then hot-pressed at 1 MPa at 95° C. for 25 minutes.

### Comparative Example 1

The PO was fixed at a glass support.

The PO was pre-heated in a ventilated oven at temperature of 50° C.

Casting of an aqueous composition comprising Torlon® AI-50 as 85.7% of the TSC and SDS as 14.3% of the TSC on PO was performed at 40 μm of wet thickness to achieve a final dry coating of 1-2 μm. The supporting plate was kept at 50° C. all time during of the coating. Drying was performed at 70° C. for 30 min in ventilated oven. Once dried, the same procedure was repeated for the second side of the PO.

### Comparative Example 1a

The same procedure for preparing a coated separator as in Comparative Example 1 was followed. The coated PO was then hot-pressed at 1 MPa at 95° C. for 25 minutes.

### Comparative Example 2

The PO was fixed at a glass support.

Casting of the solution obtained as in Comparative example 1 onto the PO was performed at 40 μm of wet thickness to achieve a final dry coating of 1-2 μm. Drying was performed drying was performed at room temperature for 15 hours. Once dried, the same procedure was repeated for the second side of the PO.

### Comparative Example 2a

The same procedure for preparing a coated separator as in Comparative Example 2 was followed. The coated PO was then hot-pressed at 1 MPa at 95° C. for 25 minutes.

Thermal Shrinkage Test:

The separators coated on both side of Examples 1 to 3 and of Comparative Examples 1 and 2 and the pressed separators coated on both side of Examples 1a to 3a and of Comparative Examples 1a and 2a were tested for the thermal shrinkage. The test was performed putting a specimen of coated PO having size of 6 cm (casting direction=CD) and 5 cm (transversal direction=TD) in a ventilated oven for 1 hour at 130° C. After the test, the dimensions CD and TD of the separator were checked and compared with the same before the treatment.

Measurement of shrinkage in casting direction (CD) and in trasversal direction (TD) of the coated separators of the invention were compared with those of the non-coated PO and with PO coated with non lithiated PAI (AI-50). The results are reported in Table 1.

Quality of Coating:

The coated separators prepared in the examples above were visually evaluated for the presence of defects such as cracks, pinholes or inhomogeneities.

The following scale of values was applied:

0=no defects

1=minor defects

TABLE 1

| | CD (%) | TD (%) | DEFECTS |
|---|---|---|---|
| Non-coated | 24% | 29% | |
| Non-coated | 22% | 26% | |
| Hot-pressed | | | |
| 1 | 4% | 9% | 0 |
| 1a | 5% | 8% | 0 |
| 2 | 3% | 4% | 1 |
| 2a | 7% | 16% | 1 |
| 3 | 5% | 4% | 0 |
| 3a | 3% | 6% | 0 |
| 4 | 3% | 7% | 0 |
| 4a | 3% | 7% | 0 |
| Comparative 1 | 30% | 20% | 0 |
| Comparative 1a | 17% | 14% | 0 |
| Comparative 2 | 20% | 22% | 1 |
| Comparative 2a | 16% | 16% | 1 |

The data demonstrate that the coated separators of examples 1 to 4 and 1a to 4a, prepared according to the invention, show a remarkably lower thermal shrinkage in comparison with the coatings comprising PAI and with non-coated separators. The values remain almost stable even after hot-pressing the coated separators.

In addition, the coated separators prepared according to the invention present a better compromise between thermal shrinkage and presence of defects in the coating in comparison with the coatings comprising PAL.

Adhesion:

In order to verify the adhesion of the coating to the PO, peeling test of a coated PO prepared as in Example 1, but with a single side coated, was performed. An adhesive tape was attached to the surface of the coating and the coating was peeled off from substrate at 300 mm/min and 180° by a dynamometer that allowed the measurement of the force needed to peel off the adhesive tape from the sample. Peeling strength: 1032±107 N/m.

1-15. (canceled)

16. A process for the preparation of a coated separator for use in an electrochemical cell, said process comprising the following steps:
i) providing a non-coated substrate layer [layer (P)];
ii) providing an aqueous composition (C) comprising an aqueous medium and at least one salified polyamide-imide polymer (PAI-Salt) comprising more than 50% by moles of recurring units R_{PAI} selected from the group consisting of units of any of general formulae (R_{PAI}-a) (R_{PAI}-b) and (R_{PAI}-c): 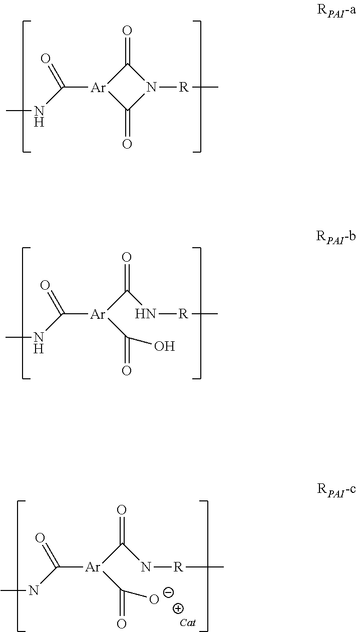
provided that R_{PAI}-c represents at least 30% by moles of recurring units in the salified polyamide-imide (PAI-Salt),
wherein:
Ar is a trivalent aromatic group; preferably Ar is selected from the group consisting of the following
structures: 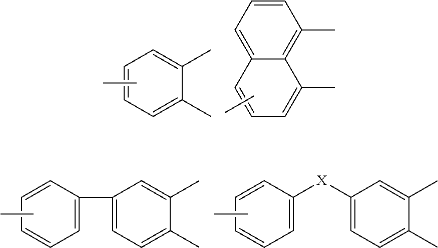
and corresponding optionally substituted structures,
wherein X is selected from the group consisting of —O—, —C(O)—, —CH₂—, —C(CF₃)₂—, —(CF₂)ₙ—, with n being an integer from 1 to 5;
X is selected from the group consisting of —O—, —C(O)—, —CH₂—, —C(CF₃)₂—, and —(CF₂)ₚ—;
n is an integer from 1 to 5;
R is a divalent aromatic group selected from the group consisting of: 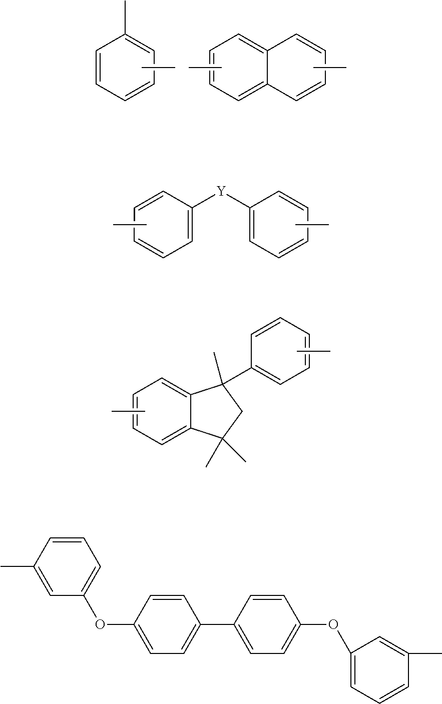
and corresponding optionally substituted structures,
Y is selected from the group consisting of —O—, —S—, —SO₂—, —CH₂—, —C(O)—, —C(CF₃)₂—, —(CF₂)_{q}—, q being an integer from 0 to 5, and
Cat⁺ is a monovalent cation;
iii) applying said composition (C) obtained in step ii) at least partially onto at least one portion of said substrate layer (P), thus providing an at least partially coated substrate layer; and
iv) drying said at least partially coated substrate layer obtained in step iii) to provide a coated separator.

17. The process according to claim 16 wherein the layer (P) is a porous substrate.

18. The process according to claim 17 wherein the layer (P) is comprising at least one material selected from the group consisting of polyethyleneterephthalate, polybutyleneterephthalate, polyester, polyacetal, polyamide, polycarbonate, polyimide, polyetheretherketone, polyethersulfone, polyphenyleneoxide, polyphenylenesulfide, polyethylenenaphthalene, polyvinylidene fluoride, polyethyleneoxide, polyacrylonitrile, polyethylene and polypropylene, or a mixture thereof.

19. The process according claim 16, wherein Cat⁺ is Li⁺ and the PAI-Salt is LiPAI.

20. The process according to claim 19 wherein the recurring units R_{PAI}-a, R_{PAI}-b, and R_{PAI}-c in the LiPAI are respectively units of formulae:

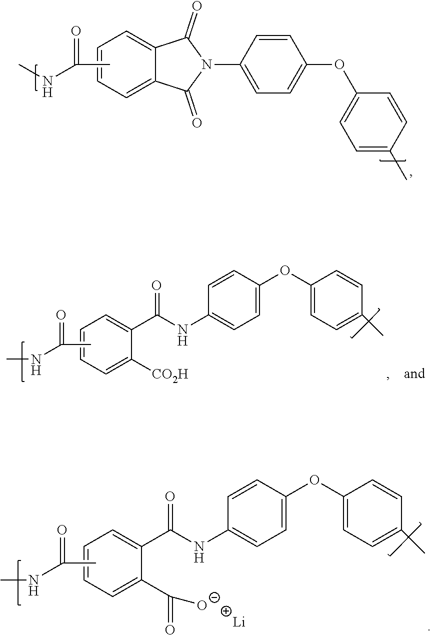

21. The process according to claim 19 wherein the recurring units R_{PAI}-a, R_{PAI}-b, and R_{PAI}-c in the LiPAI are respectively units of formulae:

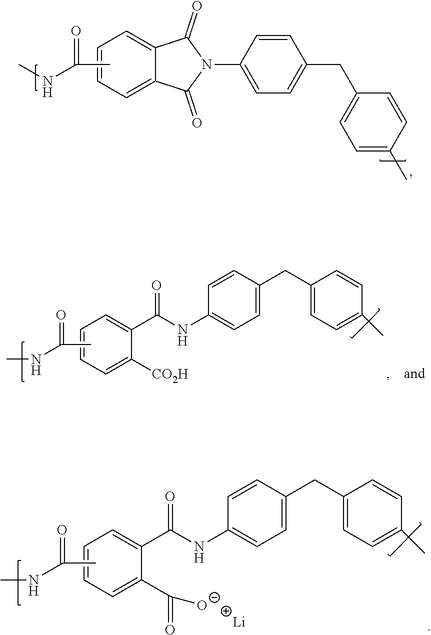

22. The process according to claim 19 wherein the recurring units R_{PAI}-a, R_{PAI}-b, and R_{PAI}-c in the LiPAI are respectively units of formulae:

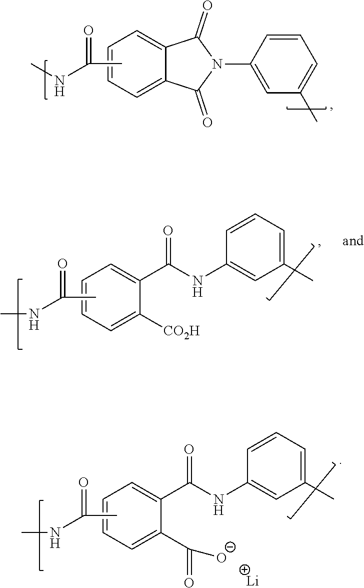

23. The process according to claim 16, wherein Ca⁺ is Na⁺.

24. The process according to claim 16, wherein the aqueous medium consists essentially of water.

25. The process according to claim 16, wherein the composition (C) further includes at least one wetting agent and/or at least one surfactant.

26. The process according to claim 16 wherein the composition (C) has a total solid content comprised between 1% and 15% wt.

27. The process according to claim 16 wherein in step iii) the composition (C) obtained in step (ii) is at least partially applied onto at least one portion of said substrate layer (P) by a technique selected from the group consisting of casting, spray coating, rotating spray coating, roll coating, doctor blading, slot die coating, gravure coating, ink jet printing, spin coating and screen printing, brush, squeegee, foam applicator, curtain coating, and vacuum coating.

28. The process according to claim 16 wherein the substrate layer (P) is pre-heated before application of composition (C).

29. The process according to claim 16 which further comprises a step of hot-pressing the coated separator obtained in step iv).

30. A coated separator for an electrochemical cell obtainable by the process according to claim 16.
